(19) United States
(12) Patent Application Publication
(10) Pub. No.: US 2014/0214922 A1
(43) Pub. Date: Jul. 31, 2014

(54) METHOD OF PROVIDING VIRTUAL MACHINE AND SERVICE GATEWAY FOR REAL-TIME VIRTUAL DESKTOP SERVICE

(71) Applicant: Electronics and Telecommunications Research Institute, (unknown)

(72) Inventors: Dae-Won KIM, Daejeon (KR); Sun-Wook Kim, Hwaseong-si (KR); Soo-Cheol Oh, Daejeon (KR); Myeong-Hoon Oh, Daejeon (KR); Hak-Jae Kim, Daejeon (KR); Jung-Hyun Cho, Daejeon (KR); Jong-Bae Moon, Daejeon (KR); Seong-Woon Kim, Gyeryong-si (KR); Hag-Young Kim, Daejeon (KR)

(73) Assignee: Electronics and Telecommunications Research Institute

(21) Appl. No.: 14/136,936

(22) Filed: Dec. 20, 2013

(30) Foreign Application Priority Data
Jan. 31, 2013 (KR) 10-2013-0011032

(51) Int. Cl. H04L 29/06; G06F 9/455

(52) U.S. Cl. CPC H04L 63/102; G06F 9/45533
USPC 709/203

(57) ABSTRACT

Disclosed herein is a method of providing a virtual machine and service gateway for real-time virtual desktop service. The service gateway includes a user information management unit, a virtual machine information management unit, and a virtual machine generation unit. The user information management unit authenticates user information. The virtual machine information management unit generates access information about a virtual machine corresponding to the user information, and provides the generated access information to a client unit. The virtual machine generation unit selects a service provider server in response to a request from a client unit, and generates a virtual machine in the selected service provider server.

### CROSS REFERENCE TO RELATED APPLICATION

This application claims the benefit of Korean Patent Application No. 10-2013-0011032, filed on Jan. 31, 2013, which is hereby incorporated by reference in its entirety into this application.

### BACKGROUND OF THE INVENTION

1. Technical Field

The present invention relates generally to a method of providing a virtual machine for real-time virtual desktop service and, more particularly, to technology that provides a virtual desktop environment to a remote user in a server virtualization environment and allocates a real-time virtual desktop to a user.

2. Description of the Related Art

Conventional methods of providing a virtual desktop include a method of providing a terminal service called Remote Desktop Connection (RDC) using a Remote Desktop Protocol (RDP), which is provided by Microsoft Corp., a method of providing a terminal service called Virtual Network Computing (VNC) using a Remote FrameBuffer (RFB) protocol in Linux, and a method of providing a terminal service solution as a protocol called PC-over-IP (PCoIP), which is provided by Teradici Corp.

In order to perform a virtual desktop service using the conventional methods, a virtual desktop function should be provided to each user. In order to provide the virtual desktop function, corresponding devices (e.g., a CPU, memory, an HDD, and a USB) should be allocated to the user, and a user OS image should be allocated.

Virt-tool, Virt-manager, etc., that is, open tools, are used to provide this function, and a virtual machine for a user may be generated and created using a program, such as the Xendesktop of Citrix Systems Inc., VMware Fusion, or Workstation. However, these conventional methods are not suitable for providing real-time virtual service because they are manually provided tools.

U.S. Patent Application Publication No. 2012-0179820 discloses a technology that accesses resources for virtual desktop service present on public networks and allocates them to virtual machines. The technology disclosed in this patent application publication is limited in the provision of a virtual desktop service in real time.

### SUMMARY OF THE INVENTION

Accordingly, the present invention has been made keeping in mind the above problems occurring in the prior art, and an object of the present invention is to rapidly provide a virtual machine in response to a request from a user in order to provide real-time virtual desktop service in response to a request from the user in a server virtualization environment.

In accordance with an aspect of the present invention, there is provided a method of providing a virtual machine for real-time virtual desktop service, the method including transferring, by a client unit, user information to a service gateway; searching, by the service gateway, for access information about an existing virtual machine corresponding to the user information; providing, by the service gateway, the access information to the client unit; accessing, by the client unit, a service provider server corresponding to the access information; and providing, by the service provider server, the virtual machine to the client unit.

Searching for the access information about the existing virtual machine may include determining, by the service gateway, whether a user is a registered user by analyzing the user information; and, if it is determined that the user is a registered user, determining, by the service gateway, whether the existing virtual machine is present.

If it is determined that the user is not a registered user, the service gateway may request the client unit to register a user ID, a password, and virtual machine configuration information, and may generate a new user.

The virtual machine configuration information may include one or more of information about the number of CPUs, information about the number of memory devices, information about a capacity of a hard disk, and information about the type of OS of a virtual machine to be provided.

The virtual machine configuration information may include preset information that is generated in such a way that the service gateway analyzes the authority level of the user information and determines the domain name and type of OS of a virtual machine based on the analyzed authority level.

If it is determined that the existing virtual machine is not present, the service gateway may request the client unit to register virtual machine configuration information.

The service gateway may select a service provider server based on the virtual machine configuration information; and the selected service provider server may generate a virtual machine based on the virtual machine configuration information, and store the generated virtual machine.

The access information may include login information about the service provider server that provides the virtual machine.

The login information may include information about the address and port number of the service provider server.

The login information may be encrypted using a password method previously agreed between the client unit and the service provider server, and the client unit may interpret the information about the address and port number of the service provider server by recognizing the login information.

In accordance with another aspect of the present invention, there is provided a service gateway for real-time virtual desktop service, the service gateway including a user information management unit configured to authenticate user information; a virtual machine information management unit configured to generate access information about a virtual machine corresponding to the user information, and to provide the generated access information to a client unit; and a virtual machine generation unit configured to select a service provider server in response to a request from the client unit, and to generate a virtual machine in the selected service provider server.

The user information management unit may determine whether a user is a registered user by analyzing the user information provided by the client unit; and, if it is determined that the user is a registered user, the virtual machine information management unit may determine whether an existing virtual machine is present.

If it is determined that the user is not a registered user, the virtual machine information management unit may request the client unit to register a user ID, a password, and virtual machine configuration information, and may generate a new user.

The virtual machine configuration information may include one or more of information about the number of CPUs, information about the number of memory devices, information about the capacity of a hard disk, and information about the type of OS of a virtual machine to be provided.

The virtual machine configuration information may include preset information that is generated in such a way that the virtual machine information management unit analyzes the authority level of the user information and determines the domain name and type of OS of a virtual machine based on the analyzed authority level.

If it is determined that the existing virtual machine is not present, the virtual machine information management unit may request the client unit to register virtual machine configuration information.

The access information may include the address and port number of a service provider server that provides the virtual machine.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a system for real-time virtual desktop service according to an embodiment of the present invention;

FIG. 2 is a diagram showing the configuration of a system for virtual desktop service, including a service gateway, according to an embodiment of the present invention;

FIG. 3 is a diagram showing the construction of the service gateway for real-time virtual desktop service according to an embodiment of the present invention;

FIG. 4 is a diagram showing a method of providing a virtual machine for real-time virtual desktop service according to an embodiment of the present invention;

FIG. 5 is a diagram showing an interface for the method of providing a virtual machine for real-time virtual desktop service according to an embodiment of the present invention;

FIG. 6 is a diagram showing an interface for the method of providing a virtual machine for real-time virtual desktop service according to an embodiment of the present invention;

FIG. 7 is a diagram showing an interface for the method of providing a virtual machine for real-time virtual desktop service according to an embodiment of the present invention; and

FIG. 8 is a diagram showing an interface for the method of providing a virtual machine for real-time virtual desktop service according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted. The embodiments of the present invention are intended to fully describe the present invention to a person having ordinary knowledge in the art. Accordingly, the shapes, sizes, etc. of elements in the drawings may be exaggerated to make the description clear.

Embodiments of the present invention will be described in detail below with reference to the accompanying drawings.

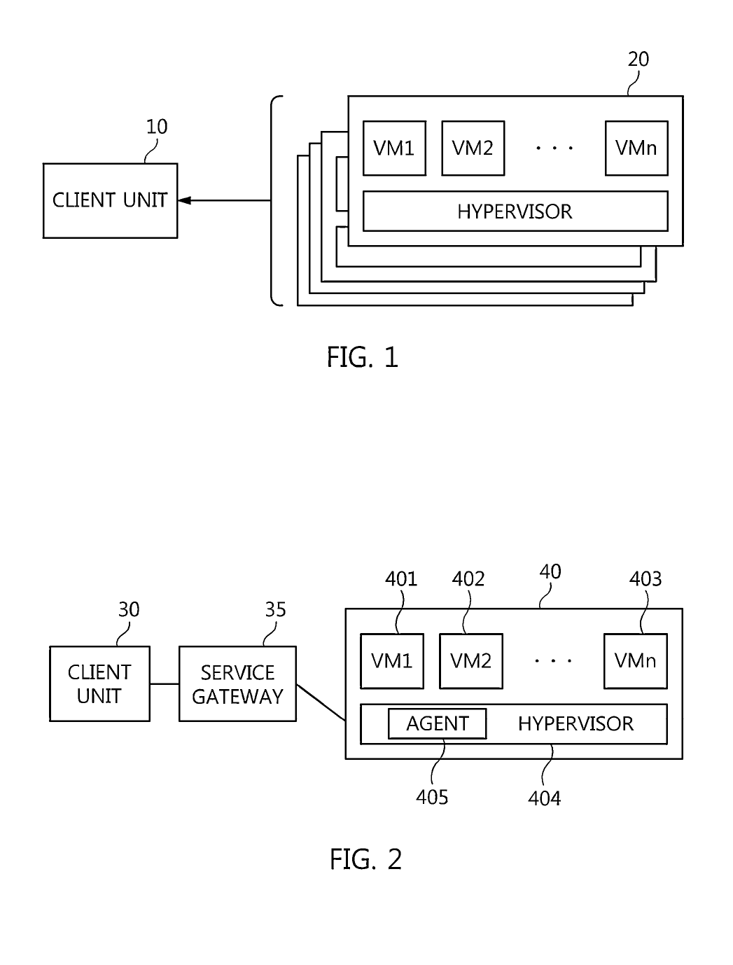

FIG. 1 is a diagram showing the configuration of a system for real-time virtual desktop service according to an embodiment of the present invention.

Referring to FIG. 1, the system for real-time virtual desktop service according to this embodiment of the present invention includes a client unit 10 and a service provider server 20.

The client unit 10 requests the service provider server 20 to allocate a virtual machine, and is provided with a virtual machine service through the allocated virtual machine.

The service provider server 20 allows a user to access virtual machines, generated over a hypervisor, through the client unit 10 using an access protocol, and allows the virtual machines stored in the service provider server 20 to be used.

In this case, in order to provide a virtual machine to a user, a user profile (i.e., a user information file), a user OS image, and a user disk image are required.

FIG. 2 is a diagram showing the configuration of a system for virtual desktop service, including a service gateway, according to an embodiment of the present invention.

Referring to FIG. 2, the system for virtual desktop service, including a service gateway, according to this embodiment of the present invention includes a client unit 30, a service gateway 35, and a service provider server 40.

The client unit 30 transfers a request command to allocate and use a virtual machine to the service provider server 40 through the service gateway 35.

The service gateway 35 authenticates the user of the client unit 30, and performs a permission procedure regarding whether to assign task rights.

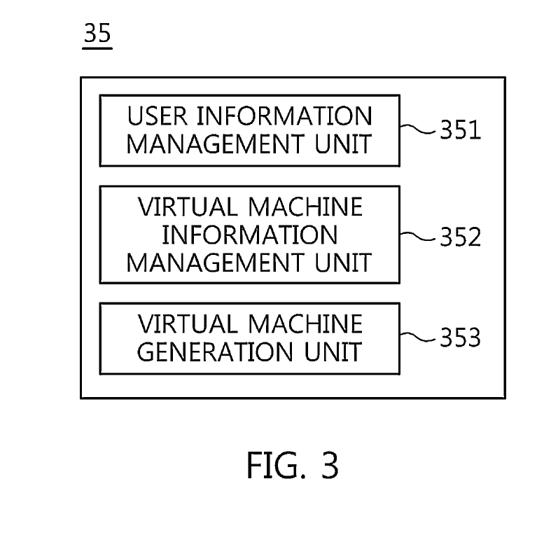

The service gateway 35 will be described later in detail with reference to FIG. 3.

The service provider server 40 includes a plurality of virtual machines 401, 402, and 403 and a hypervisor 404.

The hypervisor 404 includes an agent 405 for executing a request command received from the client unit 30 and transferring the results of the execution to the client unit 30 through the service gateway 35.

FIG. 3 is a diagram showing the construction of the service gateway 35 for real-time virtual desktop service according to an embodiment of the present invention.

Referring to FIG. 3, the service gateway 35 for real-time virtual desktop service according to this embodiment of the present invention includes a user information management unit 351, a virtual machine information management unit 352, and a virtual machine generation unit 353.

The user information management unit 351 authenticates user information that is provided by a user through a client unit.

The user information management unit 351 can determine whether a user is a registered user by analyzing the user information that is provided by the client unit.

The virtual machine information management unit 352 generates virtual machine access information corresponding to the user information provided through the client unit, and provides the virtual machine access information to the client unit.

The access information may include the address and port number of a service provider server which provides a virtual machine.

If, as a result of the determination, it is determined that the user is a registered user based on the user information that is analyzed by the user information management unit 351, the virtual machine information management unit 352 may determine whether an existing virtual machine is present.

If, as a result of the determination, it is determined that the user is not a registered user based on the user information that is analyzed by the user information management unit 351, the virtual machine information management unit 352 may request the client unit to request a user ID, a password, and virtual machine configuration information, thereby generating a new user.

The virtual machine configuration information may include one or more of information about the number of CPUs, information about the number of memory devices, information about the capacity of a hard disk, and information about the type of OS of a virtual machine to be provided.

The virtual machine configuration information may further include preset information that is generated in such a way that the virtual machine information management unit 352 analyzes the authority level of the user information and determines the domain name of the virtual machine and the type of OS based on the analyzed authority level.

Meanwhile, if, as a result of the determination, it is determined that an existing virtual machine corresponding to the user information is not present, the virtual machine information management unit 352 may request the client unit to register virtual machine configuration information.

In response to the request from the client unit, the virtual machine generation unit 353 selects a service provider server, and generates the virtual machine in the selected service provider server.

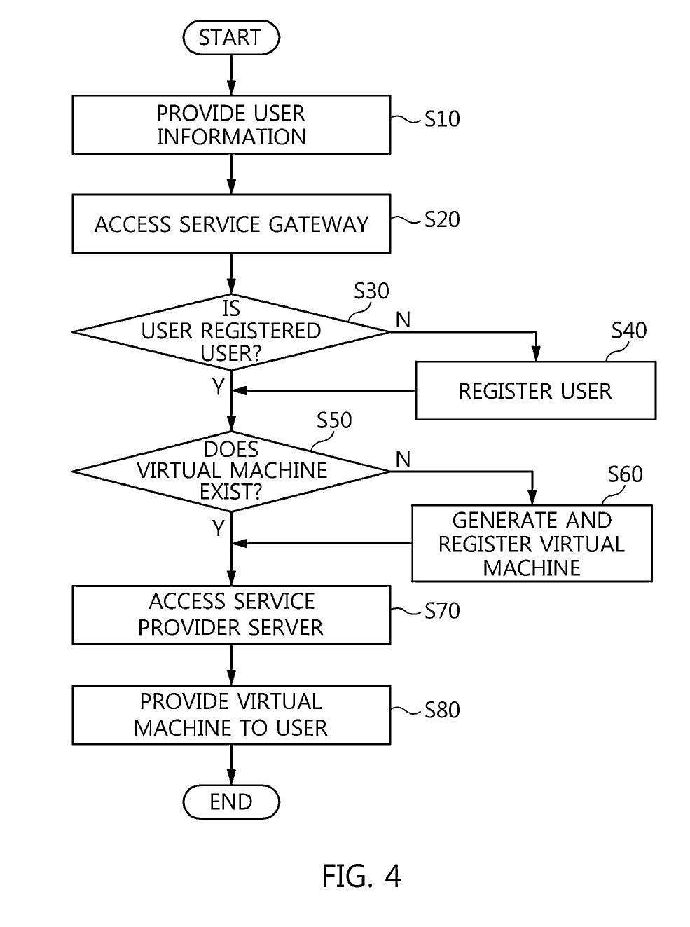

FIG. 4 is a diagram showing a method of providing a virtual machine for real-time virtual desktop service according to an embodiment of the present invention.

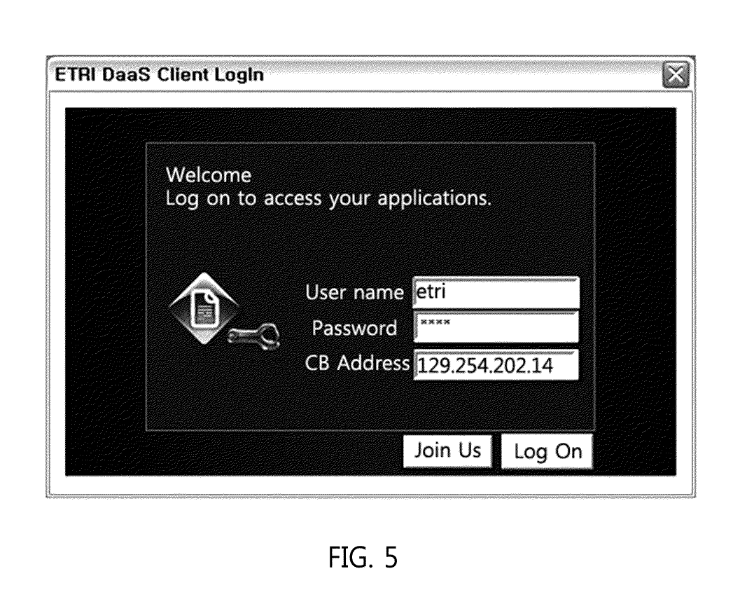

Furthermore, FIGS. 5 to 8 are diagrams showing the processes of the method of providing a virtual machine for real-time virtual desktop service in an interface form according to embodiments of the present invention.

Referring to FIG. 4, in the method of providing a virtual machine for real-time virtual desktop service according to an embodiment of the present invention, first, a client unit attempts access to the service gateway by transferring user information to the service gateway at steps S10 and S20.

The client unit may be a PC or a mobile device.

Steps S10 and S20 will be described in detail with reference to FIG. 5. A user enters user information corresponding to a user name and a password, and a CB address, that is, the on-line address of the service gateway, in an access interface screen that is displayed on the PC or mobile device.

The client unit attempts access to an on-line server corresponding to the CB address, and simultaneously transfers the user name and the password to the on-line server.

Thereafter, the service gateway determines whether the user is a registered user by analyzing the user information at step S30.

If, as a result of the determination, it is determined that the user is not a registered user based on the analyzed user information, the service gateway requests the client unit to register a user ID, a password, and virtual machine configuration information, thereby generating a new user at step S40.

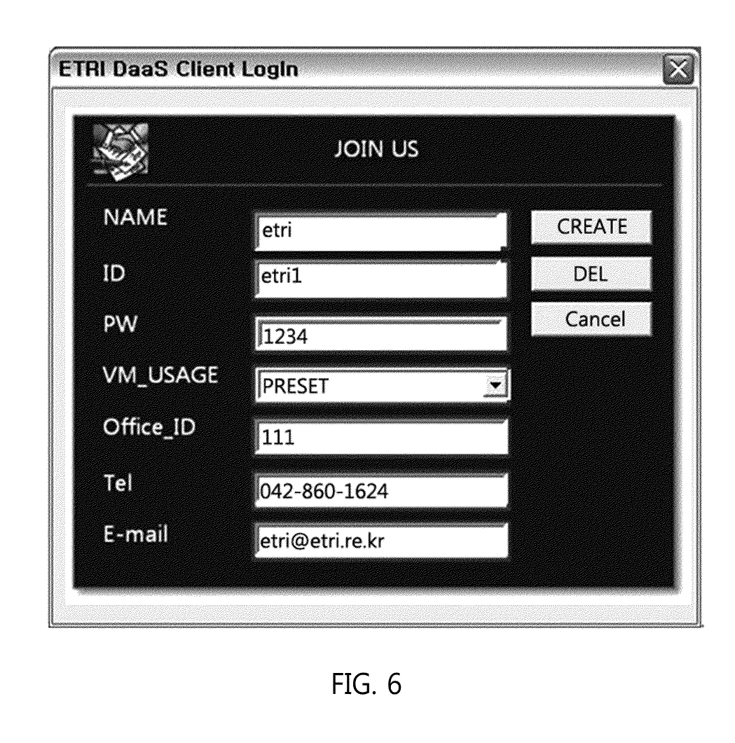

Step S40 will be described in detail with reference to FIG. 6. A new user is generated by entering a name, an ID, a password PW, virtual machine configuration information VM_USAGE, an office name Office_ID, a telephone number Tel, and an e-mail address E-mail in a registration interface screen in order to register the user.

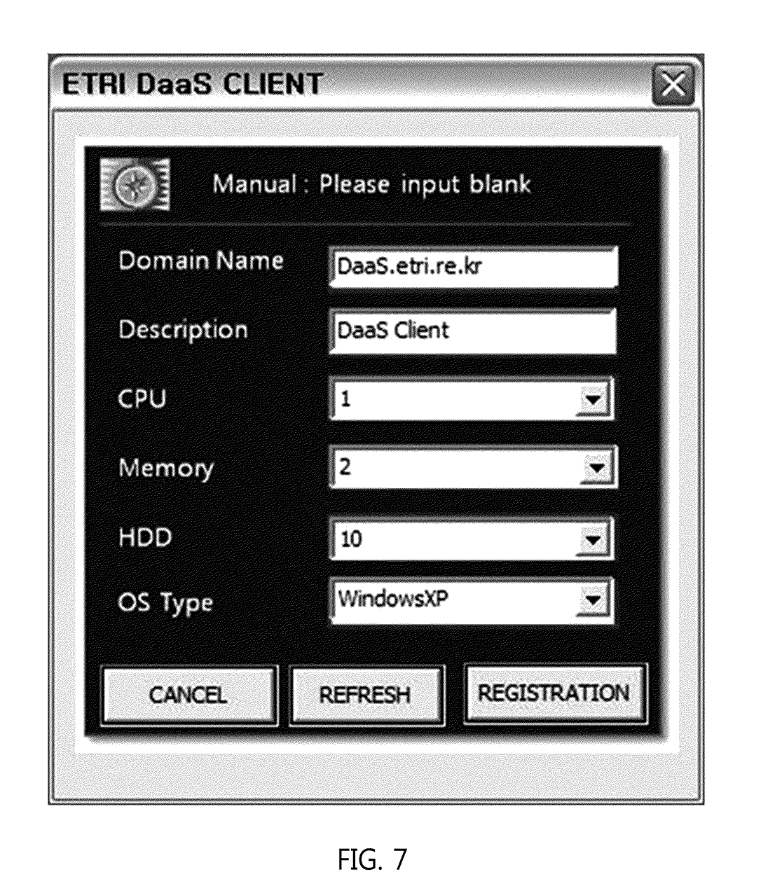

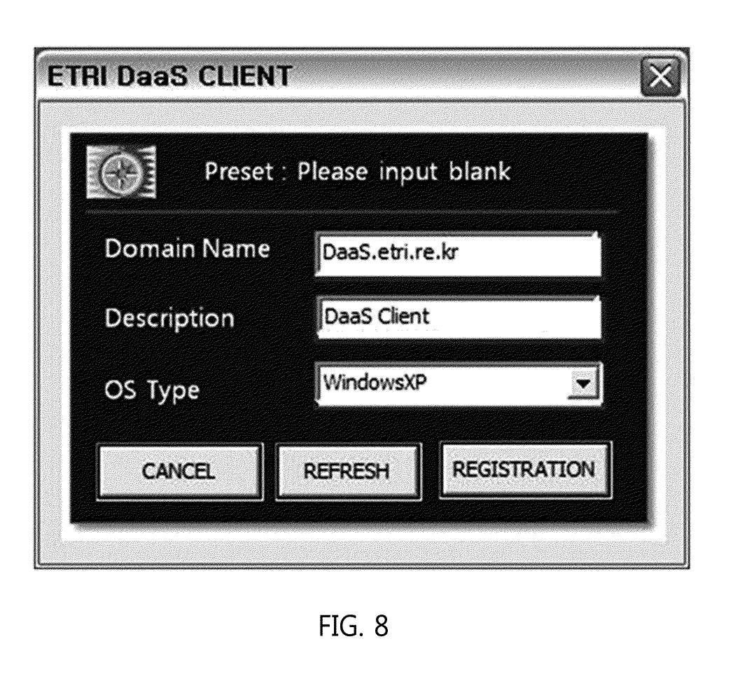

A process of configuring the virtual machine configuration information will be described in detail later with reference to FIGS. 7 and 8.

Thereafter, the service gateway determines whether an existing virtual machine corresponding to the user information is present at step S50.

If, as a result of the determination, it is determined that an existing virtual machine corresponding to the user information is not present, the service gateway generates and registers a new virtual machine by requesting the client unit to register the virtual machine configuration information at step S60.

In this case, a method of configuring the virtual machine configuration information may be performed using a preset method or a manual method.

Referring to FIG. 7, if the virtual machine configuration information is configured using the manual method, information about the domain name of the virtual machine, a description of the virtual machine, and the number of CPUs, the number of memory devices, the capacity of a hard disk, and the type of OS of the virtual machine to be provided.

Referring to FIG. 8, if the virtual machine configuration information is configured using the preset method, the service gateway analyzes an authority level regarding the user information, and determines the domain name and the type of OS of the virtual machine based on the analyzed authority level.

For example, the domain name and the type of OS to be provided may be determined by analyzing the rank of a user or the available service level of a user based on the office name that is entered at step S40.

The service gateway selects one of a plurality of service provider servers that provides virtual machines based on the virtual machine configuration information configured using the preset method or the manual method, and generates a virtual machine in the service provider server.

In this case, a predetermined virtual machine configuration information (template) is copied to a designated location, and a pre-produced image is renamed in a specific location.

Therefore, each service provider server needs to previously set a template file suitable for the service provider server and have the template file at a fixed location, and needs to have an image suitable for its capacity by default.

When the virtual machine is generated as described above, the service provider server allocates access information to the client unit.

In this case, the access information may include the address and port number of the service provider server that provides the virtual machine.

Thereafter, the client unit accesses the service provider server based on the allocated access information at step S70.

The service provider server renames a user OS image and a user disk image, corresponding to the virtual machine configuration information configured by the user, without requiring a process of copying a virtual machine image prepared in advance and provides the user OS image and the user disk image to the user at step S80.

After the allocation has been completed, the service provider server may send an allocation completion message to the user, and the user may perform booting.

As described above, according to the present invention, a user OS image and a user disk image to be allocated to the user for virtual desktop service can be provided rapidly.

Furthermore, the load imposed on a server in a server virtualization environment can be significantly reduced because a previously prepared disk image is allocated and thus operations, such as the generation of a virtual machine and the coping of an image, are eliminated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a virtual machine for real-time virtual desktop service, the method comprising:
transferring, by a client unit, user information to a service gateway;
searching, by the service gateway, for access information about an existing virtual machine corresponding to the user information;
providing, by the service gateway, the access information to the client unit;
accessing, by the client unit, a service provider server corresponding to the access information; and
providing, by the service provider server, the virtual machine to the client unit.

2. The method of claim 1, wherein searching for the access information about the existing virtual machine comprises:
determining, by the service gateway, whether a user is a registered user by analyzing the user information; and
if it is determined that the user is a registered user, determining, by the service gateway, whether the existing virtual machine is present.

3. The method of claim 2, wherein, if it is determined that the user is not a registered user, the service gateway requests the client unit to register a user ID, a password, and virtual machine configuration information and generates a new user.

4. The method of claim 3, wherein the virtual machine configuration information comprises one or more of information about a number of CPUs, information about a number of memory devices, information about a capacity of a hard disk, and information about a type of OS of a virtual machine to be provided.

5. The method of claim 3, wherein the virtual machine configuration information comprises preset information that is generated in such a way that the service gateway analyzes an authority level of the user information and determines a domain name and type of OS of a virtual machine based on the analyzed authority level.

6. The method of claim 3, wherein if it is determined that the existing virtual machine is not present, the service gateway requests the client unit to register virtual machine configuration information.

7. The method of claim 6, wherein:
the service gateway selects a service provider server based on the virtual machine configuration information; and
the selected service provider server generates a virtual machine based on the virtual machine configuration information, and stores the generated virtual machine.

8. The method of claim 1, wherein the access information comprises login information about the service provider server that provides the virtual machine.

9. A service gateway for real-time virtual desktop service, the service gateway comprising:
a user information management unit configured to authenticate user information;
a virtual machine information management unit configured to generate access information about a virtual machine corresponding to the user information, and to provide the generated access information to a client unit; and
a virtual machine generation unit configured to select a service provider server in response to a request from the client unit, and to generate a virtual machine in the selected service provider server.

10. The service gateway of claim 9, wherein:
the user information management unit determines whether a user is a registered user by analyzing the user information provided by the client unit; and
if it is determined that the user is a registered user, the virtual machine information management unit determines whether an existing virtual machine is present.

11. The service gateway of claim 10, wherein, if it is determined that the user is not a registered user, the virtual machine information management unit requests the client unit to register a user ID, a password, and virtual machine configuration information, and generates a new user.

12. The service gateway of claim 11, wherein the virtual machine configuration information comprises one or more of information about a number of CPUs, information about a number of memory devices, information about a capacity of a hard disk, and information about a type of OS of a virtual machine to be provided.

13. The service gateway of claim 11, wherein the virtual machine configuration information comprises preset information that is generated in such a way that the virtual machine information management unit analyzes an authority level of the user information and determines a domain name and type of OS of a virtual machine based on the analyzed authority level.

14. The service gateway of claim 10, wherein, if it is determined that the existing virtual machine is not present, the virtual machine information management unit requests the client unit to register virtual machine configuration information.

15. The service gateway of claim 9, wherein the access information comprises an address and port number of a service provider server that provides the virtual machine.
